(19) United States
(12) Patent Application Publication
(10) Pub. No.: US 2017/0298595 A1
(43) Pub. Date: Oct. 19, 2017

(54) SURROUNDING MONITORING DEVICE FOR WORK MACHINE

(71) Applicant: Komatsu Ltd., Tokyo (JP)

(72) Inventors: Masaomi Machida, Hiratsuka-shi (JP); Takeshi Kurihara, Hiratsuka-shi (JP)

(21) Appl. No.: 15/507,907

(22) PCT Filed: Mar. 8, 2016
(86) PCT No.: PCT/JP2016/057236

§ 371 Date: Mar. 1, 2017

(30) Foreign Application Priority Data
Mar. 31, 2015 (JP) PCT/JP2015/060294

(51) Int. Cl. E02F 9/26; G06K 9/00; E02F 9/24

(52) U.S. Cl. CPC E02F 9/26; E02F 9/24; G06K 9/00771

(57) ABSTRACT

A surrounding monitoring device for a work machine including an work device on an upper swing body includes: a plurality of cameras configured to acquire a surrounding condition of the work machine; an image processing unit configured to generate a bird's-eye image based on images imaged by the plurality of cameras; a display unit configured to display at least one of: a single camera image imaged by one of the plurality of cameras; and the bird's-eye image; and a display control unit configured to display, on the at least one of the single camera image and the bird's-eye image, distance guide information formed of linear parts with a predetermined length respectively extending perpendicularly to straight lines extending from a swing center of the upper swing body to front-rear and right-left directions, and arc parts of concentric circles connecting end parts of the linear parts.

### FIELD

The present invention relates to a surrounding monitoring device for a work machine that can display guide information that can improve work efficiency.

### BACKGROUND

In the field of work machines such as excavators, there is a work machine in which a plurality of cameras are installed on the rear and/or the side of a vehicle body, in addition to mirrors, so that an operator can visually recognize an obstacle existing in the surroundings of the vehicle body. Then, images imaged by the cameras are displayed on a monitor in a driver's cab of the work machine, as a single camera image.

Further, there is a work machine that converts images of respective cameras into images with an upper viewpoint and then composites the images of the respective cameras to generate a bird's-eye image, and displays the generated bird's-eye image on a monitor so that the operator can monitor 360-degree surroundings of the vehicle body at the same time. Further, there is a work machine that displays a single camera image imaged by a camera selected by the operator on a monitor, in addition to a bird's-eye image (see Patent Literature 1).

### CITATION LIST

### Patent Literature

Patent Literature 1: Japanese Laid-open Patent Publication No. 2012-74929

### SUMMARY

### Technical Problem

By the way, like Patent Literature 1 described above, there is a case in which a plurality of concentric circular broken lines are displayed from a swing center of an upper swing body in the bird's-eye image. These plurality of concentric circular broken lines merely display a distance from the swing center of the upper swing body. Therefore, while the operator needs to recognize a direction of an object other than an excavator, for example, a dump truck, to be specific, whether the dump truck is stopped at a right or left 90-degree position or a 180-degree position relative to the excavator that performs excavation work, or an orientation into which the dump truck is stopped, according to a status of the work, the operator visually recognizes the actual dump truck, and estimates a stop position from a bird's-eye image at a rough estimate. Therefore, there is a problem that accuracy of the stop position and the orientation of the dump truck cannot be enhanced and the work efficiency is not good.

The present invention has been made in view of the foregoing, and it is an object to provide a surrounding monitoring device for a work machine that can display guide information that can improve the work efficiency.

### Solution to Problem

To solve the above-described problem and achieve the object, a surrounding monitoring device for a work machine according to the present invention is a surrounding monitoring device for a work machine provided to a work machine including an work device on an upper swing body and includes: a plurality of cameras configured to acquire a surrounding condition of the work machine; an image processing unit configured to generate a bird's-eye image based on images imaged by the plurality of cameras; a display unit configured to display at least one of: a single camera image imaged by one of the plurality of cameras; and the bird's-eye image; and a display control unit configured to display, on the at least one of the single camera image and the bird's-eye image, distance guide information formed of linear parts with a predetermined length respectively extending perpendicularly to straight lines extending from a swing center of the upper swing body to front-rear and right-left directions, and arc parts of concentric circles connecting end parts of the linear parts.

Moreover, in the above-described surrounding monitoring device for a work machine according to the present invention, the distance guide information includes first distance guide information in which distances from the swing center of the upper swing body to right-left and front-rear directions are a distance to a counter weight provided on a rear part of the upper swing body, second distance guide information prohibiting an approach of an external working vehicle and the second distance guide information being made larger from the first distance guide information by a predetermined distance, and third distance guide information indicating a swing region of the work device in a state where the work device is extended to a maximum.

Moreover, in the above-described surrounding monitoring device for a work machine according to the present invention, the predetermined width is a width of a right and left direction of the upper swing body.

Moreover, in the above-described surrounding monitoring device for a work machine according to the present invention, direction guide information connecting end parts and a center of the linear parts is added to the distance guide information.

Moreover, the above-described surrounding monitoring device for a work machine according to the present invention further includes: a guide display setting unit configured to perform setting of display/non-display of the direction guide information, and the display control unit performs the display/non-display of the direction guide information according to the setting of the guide display setting unit.

Moreover, in the above-described surrounding monitoring device for a work machine according to the present invention, the direction guide information is positional information of a ground surface level.

Moreover, in the above-described surrounding monitoring device for a work machine according to the present invention, the display unit is provided to a remote operation seat, a control room, or a portable terminal.

According to the present invention, the distance guide information is displayed on an image from a reference position of the upper swing body to surroundings of the upper swing body. Therefore, a positional relationship between the work machine and an object positioned in the surroundings of the work machine and an orientation of the object can be easily read, and the work efficiency can be improved.

### BRIEF DESCRIPTION OF DRAWINGS

FIG. 1 is a side view illustrating an overall configuration of an excavator in which a surrounding monitoring device for a work machine as an embodiment of the present invention is mounted.

FIG. 2 is a diagram illustrating internal arrangement of a driver's cab.

FIG. 3 is a block diagram illustrating an entire control system of the excavator and a detailed configuration of a surrounding monitoring controller.

FIG. 4 is an explanatory diagram for describing processing of generating a bird's-eye image by a bird's-eye image generation unit.

FIG. 5 is a side view illustrating arrangement of cameras.

FIG. 6 is a plan view schematically illustrating arrangement of cameras.

FIG. 7 is a side view illustrating arrangement of radars.

FIG. 8 is a plan view schematically illustrating arrangement of radars.

FIG. 9 is a diagram illustrating display examples of a bird's-eye image and a single camera image.

FIG. 10 is a diagram illustrating a concept of guide information including linear parts.

FIG. 11 is a diagram illustrating display examples of a bird's-eye image and a single camera image in which the guide information including linear parts is displayed.

FIG. 12 is a diagram illustrating an example of work in a case of using the guide information including linear parts.

FIG. 13 is a diagram illustrating a display example of the guide information of when a center of the bird's-eye image is a center of gravity of an upper swing body.

FIG. 14 is a diagram illustrating an example in which a surrounding monitoring monitor is provided to a remote operation seat.

FIG. 15 is a diagram illustrating an example in which the surrounding monitoring monitor is provided to a portable terminal.

### DESCRIPTION OF EMBODIMENTS

Hereinafter, embodiments for implementing the present invention will be described with reference to the appended drawings.

[Overall Configuration of Excavator]

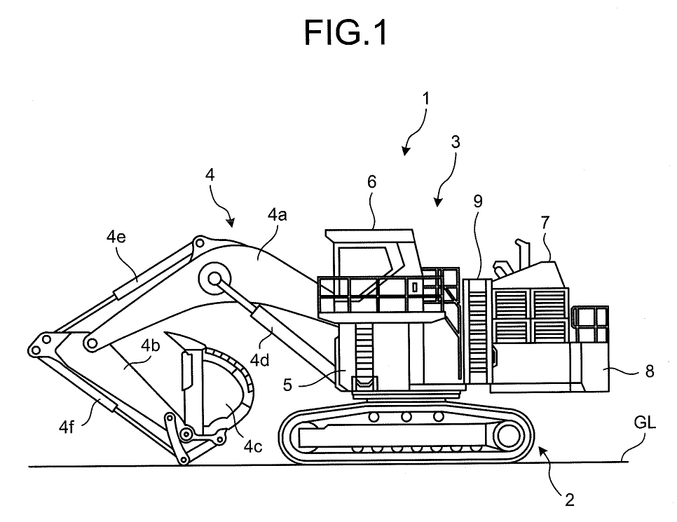

First, FIG. 1 is a side view illustrating an overall configuration of an excavator in which a surrounding monitoring device for a work machine according to an embodiment of the present invention is mounted. This excavator 1 is a large excavator, such as a mining excavator used in a mine or the like, illustrated as an example of the work machine. The excavator 1 includes a self-propelled lower traveling body 2, an upper swing body 3 arranged on the lower traveling body 2 in a freely swingable manner, and an work device 4 operated in a freely bendable and up-and-down manner in a front center of the upper swing body 3.

The work device 4 includes a boom 4a, an arm 4b, a bucket 4c, a boom cylinder 4d, an arm cylinder 4e, and a bucket cylinder 4f. A base end part of the boom 4a is revolvably coupled with the upper swing body 3. A distal end part of the boom 4a is revolvably connected with a base end part of the arm 4b. A distal end part of the arm 4b is revolvably connected with the bucket 4c. The boom cylinder 4d, the arm cylinder 4e, and the bucket cylinder 4f are hydraulic cylinders driven by working oil discharged from hydraulic pumps. The boom cylinder 4d operates the boom 4a. The arm cylinder 4e operates the arm 4b. The bucket cylinder 4f is coupled with the bucket 4c through a link member, and operates the bucket 4c. A cylinder rod of the bucket cylinder 4f performs an extension/contraction operation, so that the bucket 4c is operated. Note that, in FIG. 1, the excavator 1 functions as a backhoe with an opening of the bucket 4c facing a swing center. However, the excavator 1 may function as a front excavator with the opening of the bucket 4c facing outward from the swing center.

A driver's cab 6 is installed on a front left side part of the upper swing body 3 through a cab base 5. A power container 7 is mounted on a rear part of the upper swing body 3. In the power container 7, an engine, a hydraulic pump, a radiator, an oil cooler, and the like are accommodated. A counter weight 8 is attached to a rear end part of the upper swing body 3. An up-and-down ladder 9 is arranged on a left side part of the upper swing body 3 to be positioned in the rear of the cab base 5. The up-and-down ladder 9 assists up and down of an operator or a maintenance worker to the upper swing body 3.

[Driver's Seat]

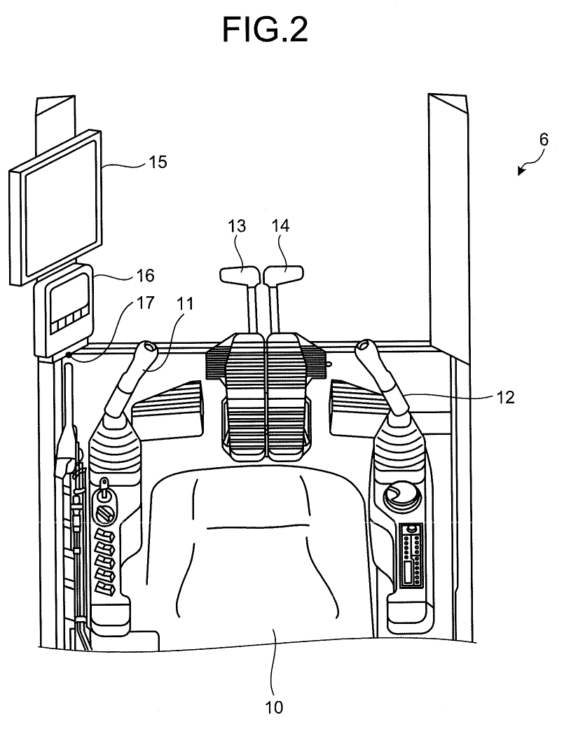

FIG. 2 is a diagram illustrating internal arrangement of the driver's cab 6. As illustrated in FIG. 2, operation levers 11 and 12 are arranged on the right and left of an operator seat 10 in the driver's cab 6. The operation lever 11 is arranged on the left hand side when an operator sits on the operator seat 10. The operation lever 11 corresponds to a swing operation of the upper swing body 3 and an operation of the arm 4b. When the operation lever 11 is operated right and left, the upper swing body 3 swings right and left, and when the operation lever 11 is operated up and down, the arm 4b is revolved in a front and rear direction. The operation lever 12 corresponds to an operation of the boom 4a, and an operation of the bucket 4c. When the operation lever 12 is operated right and left, the bucket 4c is revolved in an excavating/soil removing direction, and when the operation lever 12 is operated up and down, the boom 4a is revolved in the up and down direction. Note that the combinations of the operations of the operation levers 11 and 12, and the operations of which work devices are not limited to the present embodiment.

A travel lever 13 can advance/reverse a left-side crawler belt of the lower traveling body 2 according to an operation. Further, a travel lever 14 can advance/reverse a right crawler belt of the lower traveling body 2 according to an operation. When the travel levers 13 and 14 are operated at the same time, the right and left crawler belts are driven at the same time, and the entire excavator 1 can be advanced/reversed.

Further, a surrounding monitoring monitor 15, a monitor 16, and a buzzer 17 are arranged on a front left frame of the driver's cab 6. The surrounding monitoring monitor 15 is an input/output device formed of a touch panel, and can display at least a surrounding condition of the excavator 1 acquired by a plurality of cameras, as a bird's-eye image and a single camera image. The monitor 16 is an input/output device including a liquid crystal display unit and a key input unit. The monitor 16 can display various types of information including states of the engine, the hydraulic pump, and the like. For example, the monitor 16 can display an engine water temperature, an oil temperature, a residual amount of fuel, warning information that indicates abnormality of a device, and the like. The buzzer 17 issues a warning when an obstacle is detected by a plurality of radars. Note that information of the obstacle is also displayed on an image of the surrounding monitoring monitor 15 when the obstacle is detected.

[Overall Configuration of Control System]

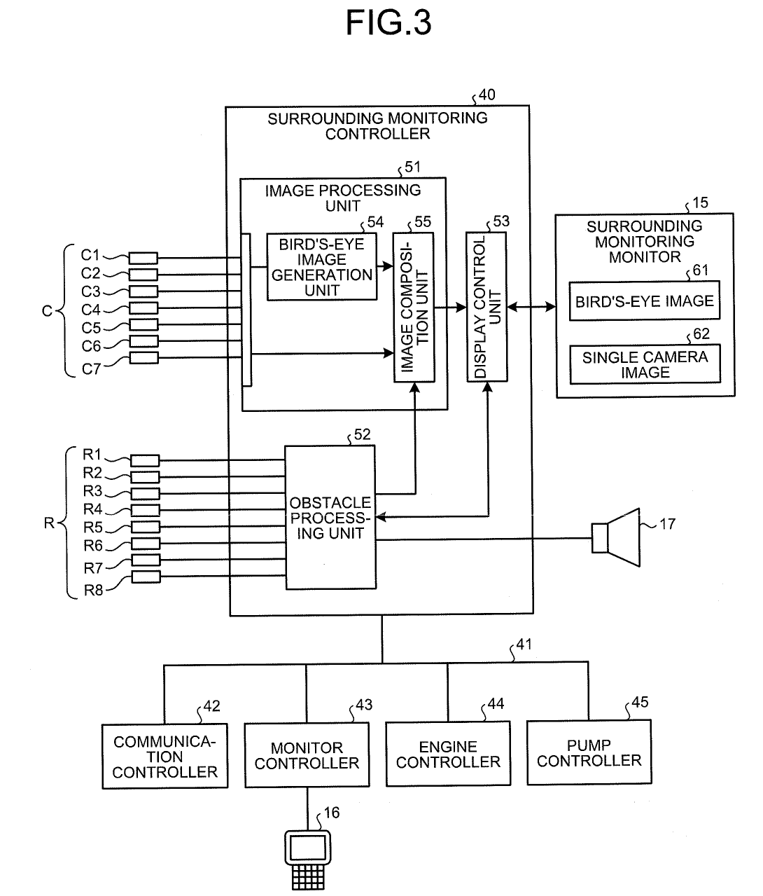

FIG. 3 is a block diagram illustrating a configuration of an overall control system of the excavator 1. As illustrated in FIG. 3, a surrounding monitoring controller 40 is connected with a CAN 41 that is one of in-vehicle networks. A communication controller 42, a monitor controller 43, an engine controller 44, a pump controller 45, and the like are connected with the CAN 41. Further, a camera group C including a plurality of cameras C1 to C7, a radar group R including a plurality of radars R1 to R8, the surrounding monitoring monitor 15, and the buzzer 17 are connected with the surrounding monitoring controller 40.

The surrounding monitoring controller 40 performs surrounding monitoring control. The surrounding monitoring controller 40 includes an image processing unit 51, an obstacle processing unit 52, and a display control unit 53.

Further, the image processing unit 51 includes a bird's-eye image generation unit 54 and an image composition unit 55.

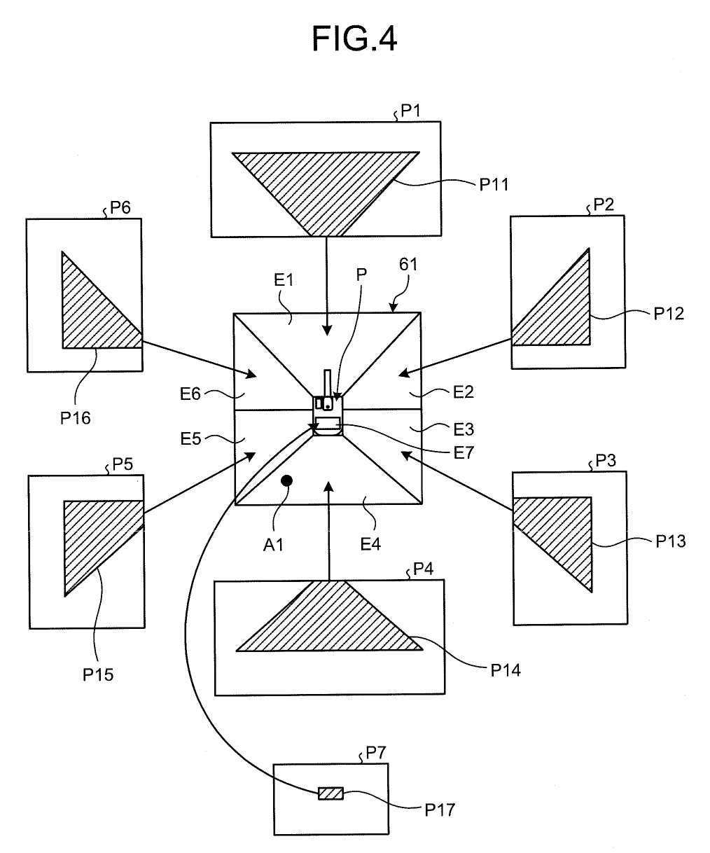

The bird's-eye image generation unit 54 generates a bird's-eye image 61 based on images obtained from the respective cameras C1 to C7. As illustrated in FIG. 4, the bird's-eye image generation unit 54 converts images P1 to P7 obtained from the respective cameras C1 to C7 into upper viewpoint images. That is, the bird's-eye image generation unit 54 converts the images P1 to P7 into images as viewed from a predetermined virtual viewpoint positioned above the excavator 1. To be specific, the bird's-eye image generation unit 54 performs image conversion to project an image from the virtual viewpoint above the excavator 1 to a predetermined virtual projection surface corresponding to a ground surface level GL. Following that, the bird's-eye image generation unit 54 cuts out converted images P11 to P17 corresponding to regions E1 to E7 of a frame in which the bird's-eye image is displayed, and composites the converted images P11 to P17 within the frame. An image P corresponding to a plan view of the excavator 1 is affixed to the bird's-eye image 61 generated by the bird's-eye image generation unit 54, in advance.

Meanwhile, the obstacle processing unit 52 detects an obstacle based on information of the radars R1 to R8. When the obstacle processing unit 52 has detected the obstacle, the obstacle processing unit 52 sounds the buzzer 17 to inform the detection of the obstacle, and outputs obstacle information such as a size and a position of the detected obstacle to the image composition unit 55. The bird's-eye image 61 and the images (single camera images 62) imaged by the respective cameras C1 to C7 are input to the image composition unit 55. When the obstacle information has been input from the obstacle processing unit 52, the image composition unit 55 generates an image obtained by compositing the obstacle information to the bird's-eye image 61 and the single camera image 62. For example, obstacle information A1 in a region E4 of FIG. 4 is composited to the bird's-eye image 61.

The display control unit 53 performs control of displaying the bird's-eye image 61 input from the image composition unit 55, and the single camera image 62 selected from the images imaged by the cameras C1 to C7, on the surrounding monitoring monitor 15.

The monitor controller 43 is connected with the monitor 16. The monitor controller 43 performs input/output control of various types of information such as information transmitted from various sensors through the CAN 41, and information input through the monitor 16. The monitor 16 can display, as described above, the engine water temperature, the oil temperature, the residual amount of fuel, the warning information that indicates abnormality of a device, and the like.

[Configurations and Arrangement of Cameras]

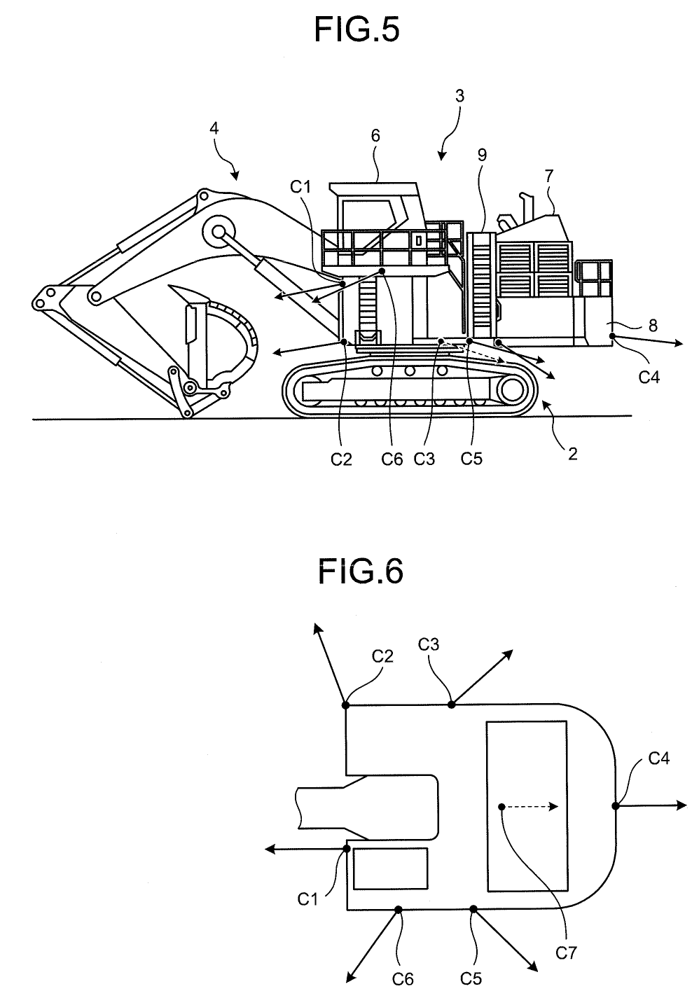

Next, configurations and arrangement of the cameras C1 to C7 will be described with reference to FIGS. 5 and 6. All of the cameras C1 to C7 may be attached to the upper swing body 3. For example, each of the cameras C1 to C7 has visual field ranges of 120 degrees (60 degrees each to the right and left) in a right and left direction, and 96 degrees in a height direction. As the cameras, a charge-coupled device (CCD) camera can be used. Further, each of the cameras C1 to C7 may include a wide dynamic range function.

As illustrated in FIGS. 5 and 6, to be specific, the camera C1 is provided on a front surface of the cab base 5 that is a lower portion of the driver's cab 6 of the upper swing body 3, and images the front of the upper swing body 3. The camera C2 is provided on a right-side front lower part of the upper swing body 3, and images the right front of the upper swing body 3. The camera C3 is provided on a right-side side-surface lower part of the upper swing body 3, and images the right rear of the upper swing body 3. The camera C4 is provided on a rear lower part center of the counter weight 8 arranged in the rear end part of the upper swing body 3, and images the rear of the upper swing body 3. The camera C5 is provided on a left-side side-surface lower part of the upper swing body 3, and images the left rear of the upper swing body 3. The camera C6 is provided on an upper left-side surface of the cab base 5, and images the left front of the upper swing body 3. The camera C7 is provided on a lower part of the power container 7, and images a lower region of the power container 7 and the counter weight 8. Since imaging ranges of adjacent cameras C1 to C7 overlap with each other, the 360-degree periphery of a close position of the excavator can be imaged.

[Configurations and arrangement of Radars]

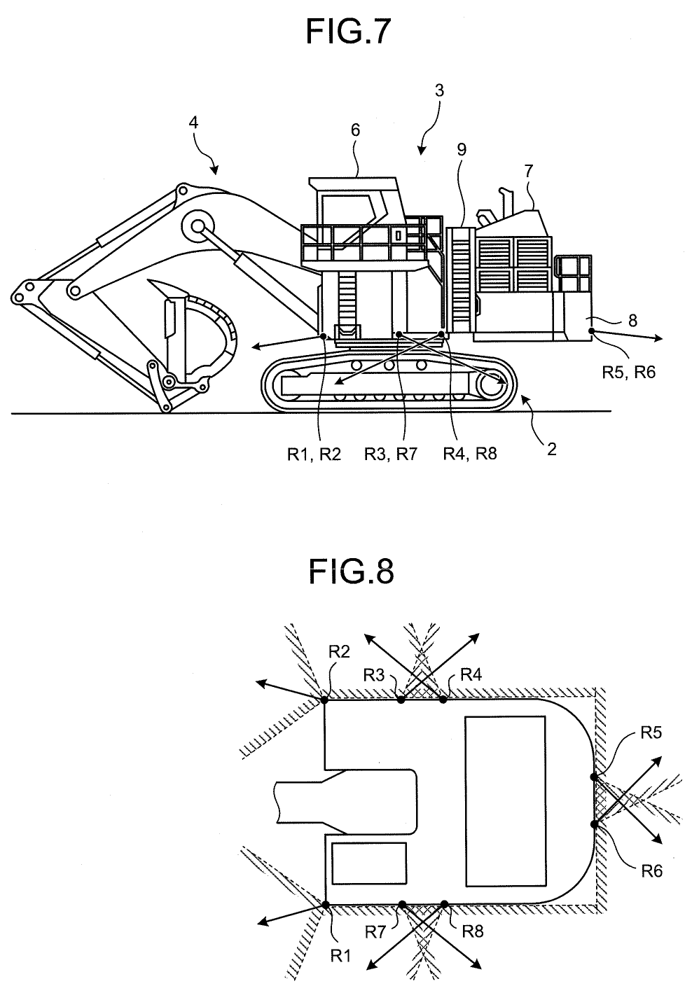

Next, configurations and arrangement of the radars R1 to R8 will be described with reference to FIGS. 7 and 8. All of the radars R1 to R8 may be provided on the upper swing body 3. The radars R1 to R8 detect a relative position and direction of an obstacle existing in the surroundings of the excavator 1, and the excavator 1. For example, the radars R1 to R8 are attached to peripheral parts of the excavator 1, as illustrated in FIGS. 7 and 8. Further, the radars R1 to R8 are ultra wide band (UWB) radars with detection angles of 80 degrees (±40 degrees) in an orientation (horizontal) direction and 16 degrees (±8 degrees) in the up and down (vertical) direction, and a maximum detection distance of 15 m or more.

As illustrated in FIGS. 7 and 8, to be specific, the radar R1 is provided on a lower left end of a front part of the upper swing body 3, and detects an obstacle in the left front of the upper swing body 3. The radar R2 is provided on a lower right end of the front part of the upper swing body 3, and detects an obstacle in the right front of the upper swing body 3. Further, installation directions of the radars R1 and R2 are adjusted not to detect the work device 4 such as the bucket 4c, and detection regions of the radars R1 and R2 do not overlap with each other. The radar R3 is provided on a right-side lower part of the upper swing body 3, and detects an obstacle in the right rear of the upper swing body 3. The radar R4 is provided at a right-side side lower part of the upper swing body 3, and detects an obstacle in the right front of the upper swing body 3. Here, the radar R3 is adjacent to the radar R4, and is arranged in front relative to the position of the radar R4. Then, the radars R3 and R4 detect obstacles in the entire right-side surface of the upper swing body 3 by irradiating the entire right-side surface with radar signals to intersect with each other. Further, the radar R5 is provided on a lower part of the counter weight 8 of the upper swing body 3, and detects an obstacle in the left rear of the upper swing body 3. The radar R6 is provided on a lower part of the counter weight 8, and detects an obstacle in the right rear of the upper swing body 3. Here, the radar R5 is adjacent to the radar R6, and is arranged on the right side relative to the position of the radar R6. Then, the radars R5 and R6 detect obstacles in the entire rear surface in the rear of the upper swing body 3 by irradiating the entire rear surface with radar signals to intersect with each other. Further, the radar R8 is provided on a left-side lower part of the upper swing body 3, and detects an obstacle in the left front of the upper swing body 3. The radar R7 is provided on a left-side side lower part of the upper swing body 3, and detects an obstacle in the left rear of the upper swing body 3. Here, the radar R8 is adjacent to the radar R7, and is arranged in the rear relative to the position of the radar R7. Then, the radars R8 and R7 detect obstacles in the entire left-side surface of the upper swing body 3 by irradiating the entire left-side surface with radar signals to intersect with each other.

[Manual Image Switching Processing of Surrounding Monitoring Monitor]

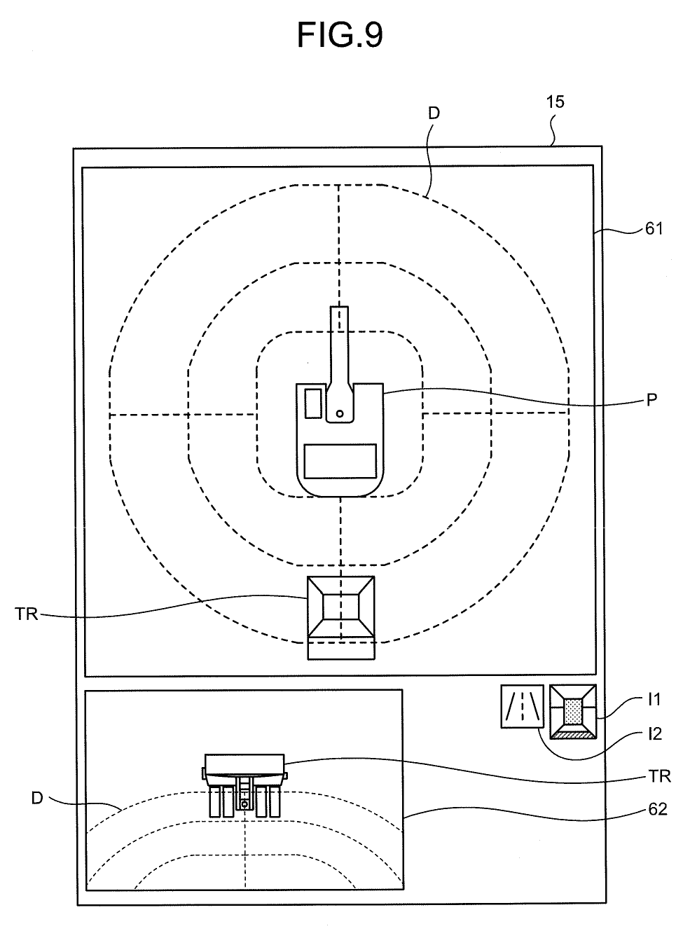

The surrounding monitoring monitor 15 illustrated in FIG. 9 is an example of an initial screen displayed when a key is turned ON. In FIG. 9, the bird's-eye image 61 is displayed in an upper region of the surrounding monitoring monitor 15, and the single camera image 62 is displayed in a lower region. Further, icons I1 and I2 are displayed in the lower right in the surrounding monitoring monitor 15. The displayed single camera image 62 is a rear image of the upper swing body 3 imaged by the camera C4. The icon I1 indicates positions of seven images displayed with the single camera image 62. The single camera image 62 illustrated in FIG. 9 is a rear image, and thus a lower-side region of the icon I1 corresponding to a rear position of the upper swing body 3 is filled. Note that a dump truck TR exists in the rear of the upper swing body 3 in the bird's-eye image 61 and the single camera image 62 illustrated in FIG. 9. It can be seen that the dump truck TR is stopped facing outside at a 180-degree position from the front where the work device 4 is arranged, in FIG. 9. Further, guide information D that indicates a distance and a direction from the upper swing body 3 described below are displayed in the bird's-eye image 61 and the single camera image 62. Further, the icon I2 (guide display setting unit) switches display/non-display of the guide information D by being selected.

[Display of Guide Information]

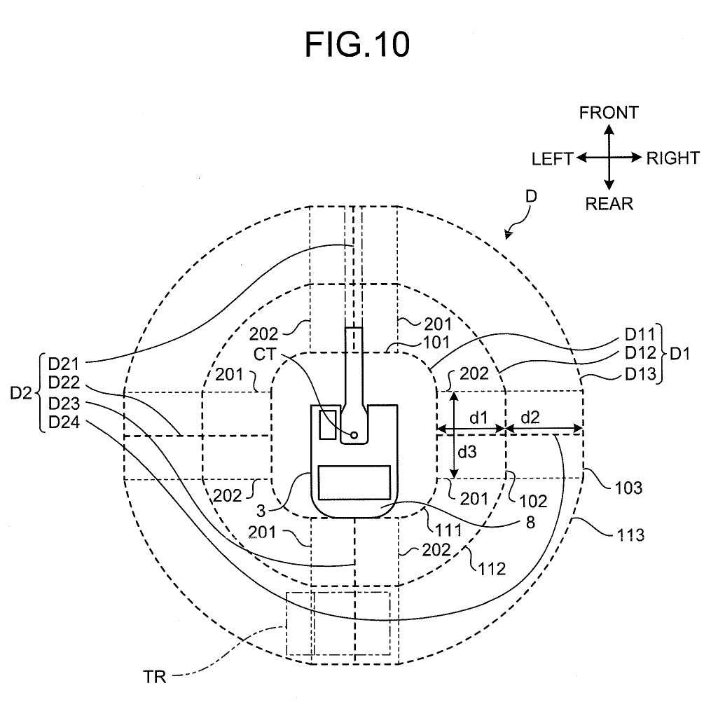

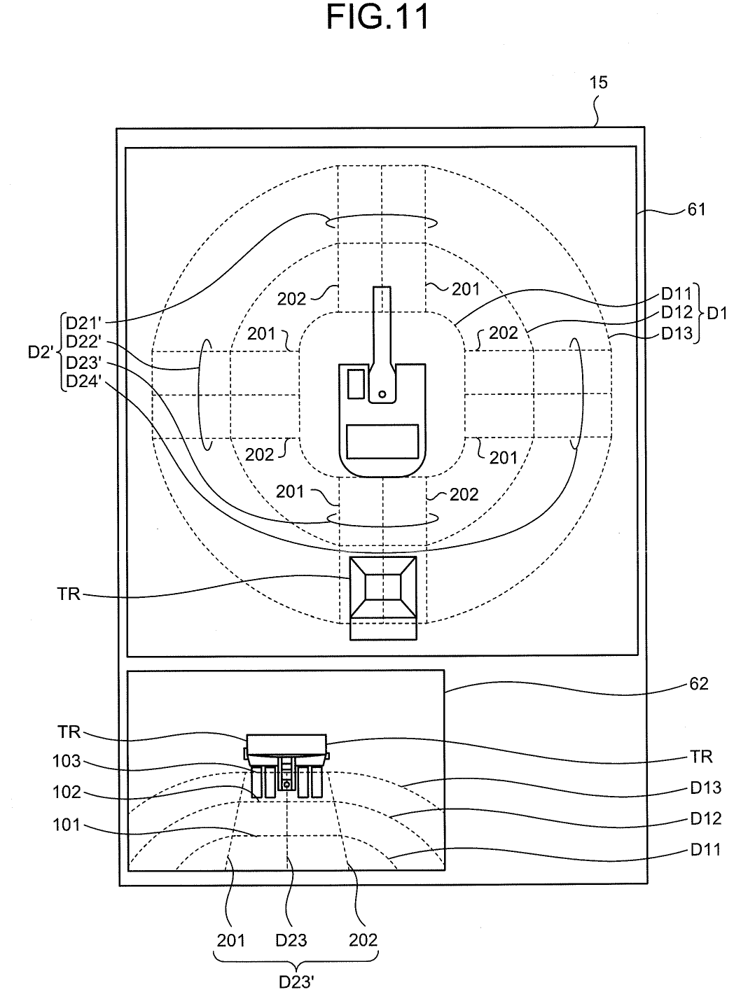

Next, the guide information D displayed in the bird's-eye image 61 and the single camera image 62 will be described. FIG. 10 is a diagram illustrating a concept of the guide information D. As illustrated in FIG. 10, the guide information D includes distance guide information D1 and direction guide information D2. Note that the guide information D is positional information of a ground surface level GL, for example. In doing so, in the single camera image 62 described below, positional relationship between the excavator and an obstacle existing in the surroundings of the excavator can be more easily distinguished.

The distance guide information D1 is information indicating a distance from a swing center CT of the upper swing body 3, and includes first distance guide information D11, second distance guide information D12, and third distance guide information D13. The first distance guide information D11 is information indicating that distances from the swing center CT of the upper swing body 3 to right-left and front-rear directions are a distance to the counter weight 8 provided on the rear part of the upper swing body 3. That is, when there is an obstacle in a region inside the first distance guide information D11, the region means that the excavator 1 may collide with the obstacle in swinging.

Further, the second distance guide information D12 is information indicating a distance that is made larger from the first distance guide information D11 by a predetermined distance d1 relative to a radius direction, and from which an approach of an external working vehicle such as the dump truck TR is prohibited. This predetermined distance d1 is a distance in which, when the excavator 1 operates the travel levers 13 and 14 and travels toward the stopped dump truck TR, the excavator 1 can be safely stopped without allowing the dump truck TR to enter the inside of the first distance guide information D11 by discontinuing the operations of the travel levers 13 and 14 after determining that the dump truck TR has entered the inside of the second distance guide information D12. The predetermined distance d1 is 2 m, for example. Therefore, the second distance guide information D12 is favorably set to cause the obstacle processing unit 52 to detect an obstacle and issue a warning such as a buzzer, when the obstacle intrudes into the region.

Further, the third distance guide information D13 is information indicating a distance that is made larger from the second distance guide information D12 by a predetermine d2 relative to the radius direction. To be specific, the third distance guide information D13 is information indicating a limit of a swing region of the work device 4 in a state where the work device 4 is stretched to the maximum. In other words, a region between the second distance guide information D12 and the third distance guide information D13 is a working region by the work device 4. In this case, even if the dump truck TR positioned between the second distance guide information D12 and the third distance guide information D13 exists, the issuance of a warning by sounding of the buzzer 17 may not be performed.

Meanwhile, the direction guide information D2 is information indicating front-rear and right-left directions of the upper swing body 3 from the swing center CT of the upper swing body 3, and includes front reference direction guide information D21, left reference direction guide information D22, rear reference direction guide information D23, and right reference direction guide information D24. The direction guide information D2 is a straight line linearly extending from the swing center CT toward the surroundings of the upper swing body 3 in the front-rear and right-left directions, and connecting intersections of the first distance guide information D11 and the third distance guide information D13.

The distance guide information D1 will be described in more detail. The first distance guide information D11 includes four linear parts 101 respectively extending perpendicularly to the front reference direction guide information D21, the left reference direction guide information D22, the rear reference direction guide information D23, and the right reference direction guide information D24, at intersection parts of the first distance guide information D11 and the guide information D21 to D24. Each of these linear parts 101 has a predetermined length d3. The linear parts 101 are respectively provided at positions separated from the swing center CT by an equal distance in the front-rear and right-left directions. This predetermined length d3 accords with a length of the right and left direction, of the upper swing body of the excavator 1. Similarly, the second distance guide information D12 and the third distance guide information D13 respectively include linear parts 102 and 103 with the same predetermined length d3.

Then, the first distance guide information D11 includes four arc parts 111 formed by connecting end parts of the four linear parts 101 with concentric circles using the swing center CT as a center. Similarly, the second distance guide information D12 has four arc parts 112 formed by connecting end parts of the four linear parts 102 with concentric circles using the swing center CT as a center. Further, the third distance guide information D13 includes four arc parts 113 formed by connecting end parts of the four linear parts 103 with concentric circles using the swing center CT as a center.

In addition to the direction guide information D21, D22, D23, and D24, parallel arrangement direction guide information 201 and 202 that connect the end parts of the linear parts 101 to 103 may be provided. Two pieces of parallel arrangement direction guide information 201 and 202 are arranged in parallel to the front reference direction guide information D21, the left reference direction guide information D22, the rear reference direction guide information D23, and the right reference direction guide information D24. Therefore, belt-like parts with the predetermined length d3 are formed in the front-rear and right-left directions of the upper swing body 3.

[Display Form of Modification of Guide Information]

FIG. 11 is a diagram illustrating a display example of the bird's-eye image 61 and the single camera image 62 in which the above-described parallel arrangement direction guide information 201 and 202 is displayed. Note that, in FIG. 11, direction guide information D21′, D22′, D23′, and D24′ that configure direction guide information D2′ are obtained by adding the parallel arrangement direction guide information 201 and 202 to the direction guide information D21, D22, D23, and D24. It can be seen that, in FIG. 11, the dump truck TR is positioned facing outside at a 180-degree position from the front where the work device 4 is arranged, and is positioned outside the second distance guide information D12. Further, lines can be displayed in a grid like manner by the linear parts 101 to 103 of the distance guide information D1 and the parallel arrangement direction guide information 201 and 202. Therefore, the direction of the working vehicle such as the dump truck TR and its orientation (when the dump truck TR is stopped in a horizontal orientation or a vertical orientation to the excavator, like the dump truck TR illustrated in FIG. 10, whether the dump truck TR is obliquely stopped can be confirmed by comparison of a side surface or a rear surface of the dump truck, and the linear parts 101 to 103), and the distance between the excavator and the working vehicle can be easily recognized. Further, while a part of the regions is displayed in a grid-like manner, the other part of the regions is displayed by arc lines. Therefore, the entire bird's-eye image is not complicated, and the distances in the image can be easily recognized.

Note that the first distance guide information D11, the second distance guide information D12, and the third distance guide information D13 that configure the guide information D favorably have color display according to the distances or display with different line types. For example, the first distance guide information D11 may be displayed by a red dotted line, the second distance guide information D12 may be displayed by a yellow dotted line, and the third distance guide information D13 may be displayed by a white, green, or blue dotted line. The same applies to the direction guide information D2. For example, it is favorable that the direction guide information D2 between the first distance guide information D11 and the second distance guide information D12 is displayed by the same yellow dotted line as the second distance guide information D12, and the direction guide information D2 between the second distance guide information D12 and the third distance guide information D13 is displayed by the same green or blue dotted line as the third distance guide information D13. Further, the guide information D may be arranged marks, instead of the lines.

[Effects by Display of Guide Lines]

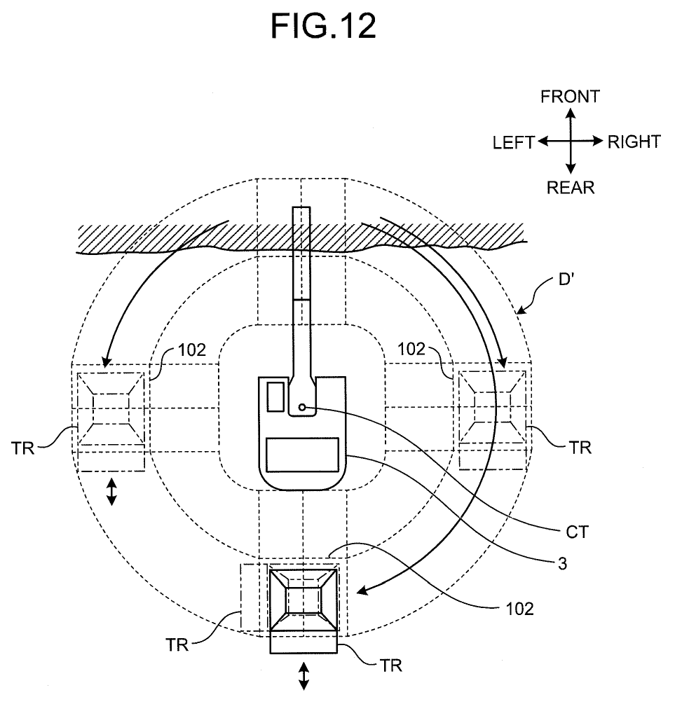

FIG. 12 is a diagram illustrating an example of work of a case using the guide information D. As illustrated in FIG. 12, when the guide information D is used, the directions from the swing center CT to the front-rear and right-left directions of the upper swing body 3, and the distance to the entire periphery can be easily recognized. To be specific, by display of the distance guide information D1, to what extent the obstacle is approaching the excavator 1 can be recognized. By including of the linear parts 101 to 103, when the dump truck TR is stopped in a horizontal orientation or a vertical orientation to the excavator, whether the dump truck TR is obliquely stopped can be confirmed, by comparison of the side surface or the rear surface of the dump truck, and the linear parts 101 to 103.

Further, by display of the direction guide information D2, when the dump truck TR is arranged at a 90-degree left position, a 90-degree right position, or a 180-degree position from the front where the work device 4 is arranged, a central part of a vessel and the 90-degree left position, the 90-degree right position, or the 180-degree position of the excavator 1 can be easily matched. Therefore, loading work of soil to the dump truck TR by the excavator 1 can be efficiently performed (when the position of the dump truck TR is deviated from the position illustrated in FIG. 12, loading work efficiency is decreased). Then, when the operator intends to arrange the dump truck TR in a region between the second distance guide information D12 and the third distance guide information D13 in the front-rear and right-left directions of the upper swing body 3, the operator of the excavator 1 can inform the operator of the dump truck TR of the fact that the excavator 1 is approaching the dump truck TR in a direction parallel to the linear part 102 and can stop the dump truck TR, by sounding a horn when the dump truck RT reaches an appropriate position on the linear part 102 of the second distance guide information D12, while monitoring the bird's-eye image 61 or the single camera image 62 and recognizing the direction with the direction guide information D2. Accordingly, the dump truck TR can be arranged in an appropriate positional relationship to the linear part 102. Especially, the position of the vessel of the dump truck TR can be guided and arranged to an appropriate position.

Further, by arrangement of such a dump truck TR, work such as 90-degree loading, 180-degree loading, and both-side loading can be performed. A rear end or a side part of the dump truck TR may be pulled up alongside the linear part 102.

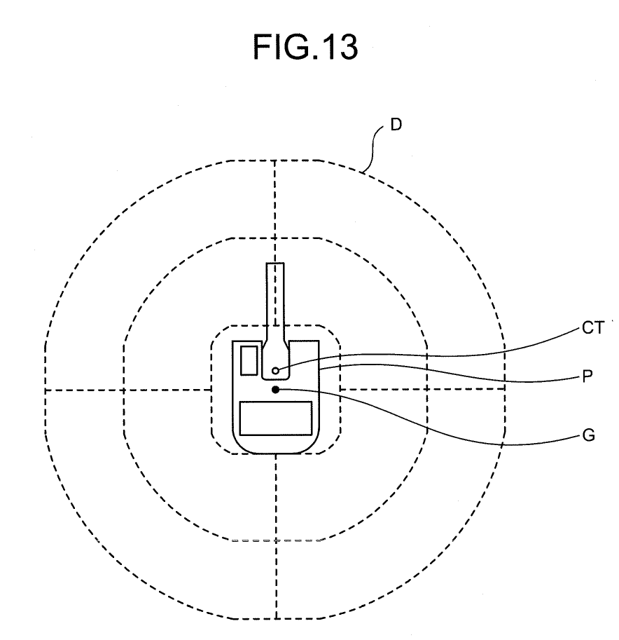

The above-described embodiment displays the guide information D around the swing center CT. However, an embodiment is not limited thereto, and the guide information D may be displayed around an arbitrary point G on the upper swing body 3, as illustrated in FIG. 13.

Note that the present invention is not limited to the above-described embodiment, and modifications and improvements within the scope in which the objective of the present invention can be achieved are included in the present invention.

The above-described embodiment includes the surrounding monitoring monitor 15 separately from the monitor 16. However, the present invention is not limited thereto, and the bird's-eye image 61 or the single camera image 62 may be displayed on the monitor 16. Further, the surrounding monitoring monitor 15 is configured as a touch panel display. However, a regular display without including a built-in touch sensor in may be used.

The above-described embodiment is configured to display the bird's-eye image 61 and the single camera image 62 on the surrounding monitoring monitor 15 at the same time. However, the present invention is not limited to the embodiment, and only a bird's-eye image or only a single camera image may be displayed on the surrounding monitoring monitor 15. Further, the above-described embodiment is configured to display only the image imaged by any of the cameras 61 to 67 in the region of a touch panel display 60 where the images imaged by the cameras 61 to 67 are displayed. However, two or more images may be able to be displayed at the same time.

Further, in the above-described embodiment, the seven cameras are provided on the periphery of the upper swing body 3. However, the surrounding monitoring device may be configured from a less number of cameras than the seven cameras, or may be configured from a larger number of cameras than the seven cameras.

Further, the above-described embodiment is configured from the radars and cameras that are in cooperation with each other. However, the present invention is not limited to the embodiment, and the surrounding monitoring device may be configured from a single camera.

In addition, the above-described embodiment discloses only the form of displaying the distance guide information D1 and the direction guide information D2 at the same time. However, only the distance guide information D1 or the direction guide information D2 may be displayed.

Further, the embodiment has been described based on the mining excavator used in a mine or the like. However, the present invention may be applied to an excavator used in a construction site.

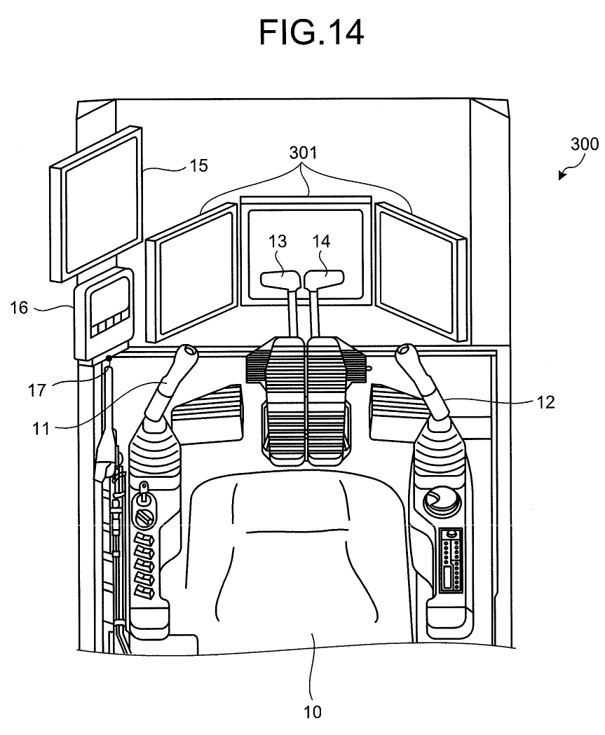

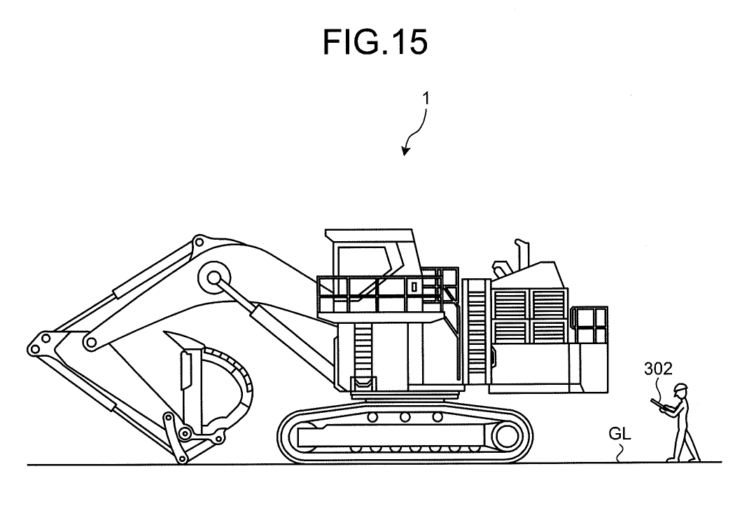

Further, the above-described embodiment has been described using the configuration in which the surrounding monitoring monitor 15 and the buzzer 17 are provided in the driver's cab 6 of the work machine. However, the surrounding monitoring monitor 15 and the buzzer 17 may be provided in another place, for example, a remote operation seat 300 illustrated in FIG. 14, for performing remote operation of the work machine, or a control room in a mine, which totally manages/controls a plurality of work machines. Further, a remote operation monitor 301 illustrated in FIG. 14 may be used as the surrounding monitoring monitor. Further, as illustrated in FIG. 15, the surrounding monitoring monitor 15 and the buzzer 17 may be provided to a portable terminal 302, and an operator may view bird's-eye image displayed on the portable terminal 302. Here, in a case where the bird's-eye image is displayed on the surrounding monitoring monitor 15 in the remote operation seat 300 or the control room, or in a case where the portable terminal 302 is used as the surrounding monitoring monitor 15 and the buzzer 17, communication means of some sort may be provided in each of the work machine, and the remote operation seat 300/the control room/the portable terminal 302, and transmission/reception of information such as the bird's-eye image may be performed.

### REFERENCE SIGNS LIST

1 Excavator
2 Lower traveling body
3 Upper swing body
4a Boom
4b Arm
4c Bucket
4d Boom cylinder
4e Arm cylinder
4f Bucket cylinder
4 Work device
5 Cab base
6 Driver's cab
7 Power container
8 Counter weight
10 Operator seat
11 and 12 Operation lever
13 and 14 Travel lever
15 Surrounding monitoring monitor
16 Monitor
17 Buzzer
40 Surrounding monitoring controller
42 Communication controller
43 Monitor controller
44 Engine controller
45 Pump controller
51 Image processing unit
52 Obstacle processing unit
53 Display control unit
54 Bird's-eye image generation unit
55 Image composition unit
61 Bird's-eye image
62 Single camera image
63 Region
101 to 103 Linear part
111 to 113 Arc part
201 and 202 Parallel arrangement direction guide information
300 Remote operation seat
301 Remote operation monitor
302 Portable terminal
A1 Obstacle information
B10 Button
C Camera group
C1 to C7 Camera
CT Swing center
D Guide information
D1 Distance guide information
D11 First distance guide information
D12 Second distance guide information
D13 Third distance guide information
D2 and D2′ Direction guide information
D21 and D21′ Front reference direction guide information
D22 and D22′ Left reference direction guide information
D23 and D23′ Rear reference direction guide information
D24 and D24′ Right reference direction guide information
E0, E1 to E8, and E20 Region
E21 Up-and-down ladder surrounding region
GL Ground surface level
I1 and I2 Icon
P, and P1 to P7 Image
P11 to P17 Converted image
R Radar group
R1 to R8 Radar
TR Dump truck

1. A surrounding monitoring device for a work machine including an work device on an upper swing body, the surrounding monitoring device comprising:
a plurality of cameras configured to acquire a surrounding condition of the work machine;
an image processing unit configured to generate a bird's-eye image based on images imaged by the plurality of cameras;
a display unit configured to display at least one of: a single camera image imaged by one of the plurality of cameras; and the bird's-eye image; and
a display control unit configured to display, on the at least one of the single camera image and the bird's-eye image, distance guide information formed of linear parts with a predetermined length respectively extending perpendicularly to straight lines extending from a swing center of the upper swing body to front-rear and right-left directions, and arc parts of concentric circles connecting end parts of the linear parts.

2. The surrounding monitoring device for a work machine according to claim 1, wherein the distance guide information includes first distance guide information in which distances from the swing center of the upper swing body to right-left and front-rear directions are a distance from the swing center of the upper swing body to a counter weight provided on a rear part of the upper swing body, second distance guide information for prohibiting an approach of an external working vehicle and the second distance guide information being made larger from the first distance guide information by a predetermined distance, and third distance guide information indicating a swing region of the work device in a state where the work device is extended to a maximum.

3. The surrounding monitoring device for a work machine according to claim 1, wherein the predetermined length is a width of a right and left direction of the upper swing body.

4. The surrounding monitoring device for a work machine according to claim 1, wherein direction guide information connecting end parts and a center of the linear parts is added to the distance guide information.

5. The surrounding monitoring device for a work machine according to claim 1, further comprising:
a guide display setting unit configured to perform setting of display/non-display of the distance guide information, wherein
the display control unit performs the display/non-display of the distance guide information according to the setting of the guide display setting unit.

6. The surrounding monitoring device for a work machine according to claim 1, wherein the distance guide information is positional information of a ground surface level.

7. The surrounding monitoring device for a work machine according to claim 1, wherein
the display unit is provided to a remote operation seat, a control room, or a portable terminal.
